(19) United States
(12) Patent Application Publication
(10) Pub. No.: US 2013/0077301 A1
(43) Pub. Date: Mar. 28, 2013

(54) LIGHT SOURCE UNIT, LIGHT SOURCE DEVICE INCLUDING LIGHT SOURCE UNIT, AND LUMINAIRE INCLUDING LIGHT SOURCE DEVICE

(71) Applicant: Junichi KIMIYA, Yokosuka-shi (JP)

(72) Inventor: Junichi KIMIYA, Yokosuka-shi (JP)

(73) Assignee: Toshiba Lighting & Technology Corporation, Kanagawa (JP)

(21) Appl. No.: 13/564,389

(22) Filed: Aug. 1, 2012

(30) Foreign Application Priority Data
Sep. 26, 2011 (JP) 2011-209925

(51) Int. Cl. F21V 29/00; F21V 7/00

(52) U.S. Cl. 362/235

(57) ABSTRACT

According to one embodiment, a light source unit includes a light source module including at least one light emitting device and a main body. The main body includes a setting surface section on which the light source module is set, a thermal radiating section disposed around the setting surface section and configured to radiate heat received from the light source module, and a thick section arranged between the setting surface section and the thermal radiating section and including an inclined plane that has thickness larger than the thickness of the setting surface section and inclines in an irradiation direction from the light source module toward the outer side.

### CROSS-REFERENCE TO RELATED APPLICATIONS

This application is based upon and claims the benefit of priority from the Japanese Patent Application No. 2011-209925 filed on Sep. 26, 2011; the entire contents of which are incorporated herein by reference.

### FIELD

Embodiments described herein relate generally to a light source unit including a light source module and a main body, which includes a setting surface section on which the light source module is set, a light source device including the light source unit, and a luminaire including the light source device.

### BACKGROUND

A luminaire including a light source device has been widely used. The light source device of the luminaire includes a light source unit. The light source unit usually includes a light source module, which is a light source, and a main body including a setting surface section on which the light source module is set.

As a light source module, a light source module including a light emitting device such as an LED is effective in terms of high power and energy saving and is put to practical use.

In such a light source unit, during lighting, the light source module and a power supply circuit for lighting the light source module generate heat. Therefore, the light source unit transfers the heat generated by the light source module and the power supply circuit to the main body formed of a thermally conductive member. The main body itself and a thermal radiating section such as thermal radiating fins formed in the main body radiate the heat.

### BRIEF DESCRIPTION OF THE DRAWINGS

FIG. 1 is a perspective view of an external configuration of a light source unit according to an embodiment;

FIG. 2 is a perspective view of an external configuration of the light source unit shown in FIG. 1 viewed from a thermal radiating section side;

FIG. 3 is a perspective view of the configuration of a luminaire including a light source device, which includes the light source unit shown in FIG. 1, and a socket;

FIG. 4 is an exploded perspective view of the light source unit shown in FIG. 1;

FIG. 5 is a V-V line sectional view of FIG. 2 for explaining the configuration of a main part of the light source unit;

FIG. 6 is a perspective view of the light source unit taken along a cross section shown in FIG. 5;

FIG. 7 is a perspective view of an external configuration of a main body shown in FIG. 4 viewed from the thermal radiating section side;

FIG. 8 is a perspective view of a VIII-VIII line cross section shown in FIG. 7; and

FIG. 9 is a perspective view of a IX-IX line cross section shown in FIG. 7.

### DETAILED DESCRIPTION

According to one embodiment, a light source unit includes: a light source module including at least one light emitting device; and a main body including: a setting surface section on which the light source module is set; a thermal radiating section disposed around the setting surface section and configured to radiate heat received from the light source module; and a thick section arranged between the setting surface section and the thermal radiating section and including an inclined plane that has thickness larger than the thickness of the setting surface section and inclines in an irradiation direction from the light source module toward the outer side.

According to another embodiment, a light source device includes: the light source unit according to the abovementioned embodiment; a power supply circuit for lighting the light source module of the light source unit; and a cap configured to store the power supply circuit and attached to the main body.

According to still another embodiment, a luminaire includes: the light source device according to the abovementioned embodiment; and a socket to which the cap of the light source device is detachably attached.

With the light source unit, the light source device including the light source unit, and the luminaire including the light source device according to the embodiments, it is possible to effectively radiate heat generated in the light source unit to the outside of the main body and reduce a loss of a light beam emitted from the light source module.

In the embodiments, definitions and technical meanings of terms are as explained below unless specifically limited.

As at least one light emitting device included in the light source module, an LED is used. However, the light emitting device is not limited to this and may be a luminous body such as an organic EL.

A light emitting surface formed by arranging the at least one light emitting device is formed in, for example, a chip on board (COB) type. However, the light emitting surface is not limited to this.

When plural light emitting devices are used, the light emitting surface is formed in, for example, a square shape with the plural light emitting devices disposed thereon lengthwise and crosswise. However, the light emitting surface is not limited to this. The plural light emitting devices may be disposed in a circular shape, an elliptical shape, or the like.

The main body is formed to have thermal conductivity by a manufacturing method such as die cast. However, the main body may be formed by any method as long as the main body has thermal conductivity. The thermal radiating section of the main body includes plural thermal radiating fins or plural needles provided in the outer circumference on the rear side of the setting surface section for the light source module. However, the thermal radiating section is not limited to this. The thermal radiating section may have any configuration as long as the configuration increases a surface area and is effective for thermal radiation action.

The inclined plane of the main body inclines from the light source module toward the outer side to divert light of the light source module to the irradiation direction. However, an angle of the inclination is not specifically limited to this and only has to be an inclination angle at which light can be reflected to be diverted to the irradiation direction of the light of the light source module.

The thickness of the inclined plane is formed to be larger than the thickness of the setting surface section. However, it is desirable to form the inclined plane to have thickness at which thermal conductivity can be increased.

An embodiment is explained in detail below with reference to the accompanying drawings.

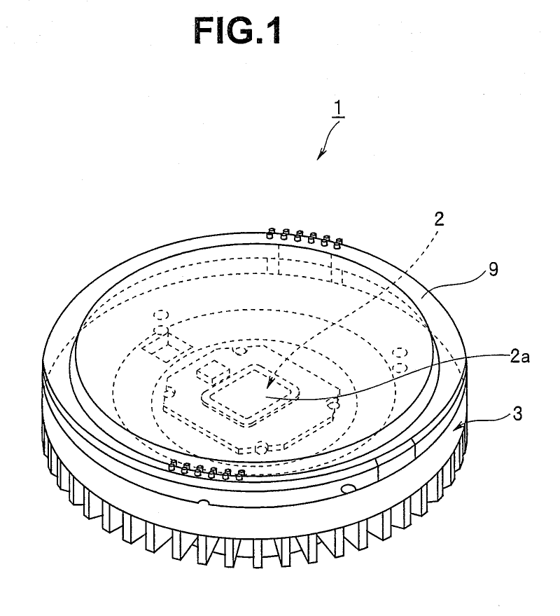

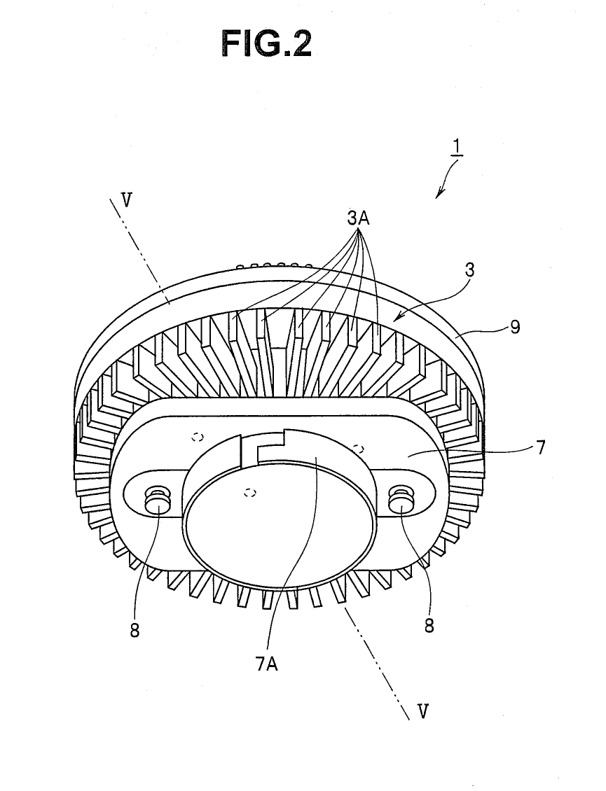

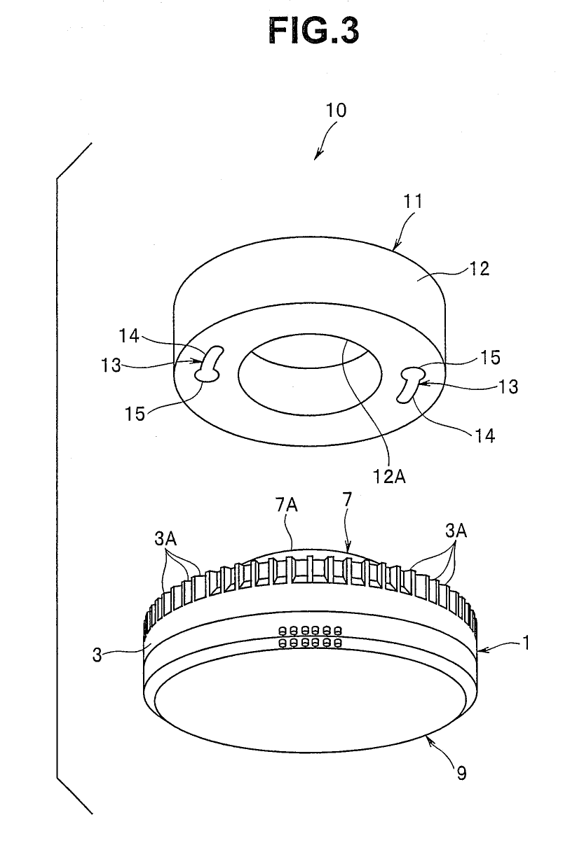

FIG. 1 is a perspective view of an external configuration of a light source unit according to the embodiment. FIG. 2 is a perspective view of an external configuration of the light source unit shown in FIG. 1 viewed from a thermal radiating section side. FIG. 3 is a perspective view of the configuration of a luminaire including a light source device, which includes the light source unit shown in FIG. 1, and a socket.

First, a schematic configuration of the luminaire according to this embodiment is explained with reference to FIG. 3.

A luminaire 10 according to this embodiment shown in FIG. 3 includes a light source unit 1 included in the light source device according to this embodiment and a socket 11.

The socket 11 is attached to a not-shown appliance main body such as a downlight. The socket 11 includes a cylindrical socket main body 12 made of synthetic resin having electrical insulation properties. A through-hole 12A is formed in the center of the socket body 12 to pierce through the socket main body 12 in the up/down direction.

A pair of socket sections 13, 13 arranged to be opposed to each other are formed on the lower surface of the socket main body 12. Connection holes 14 are formed in the socket sections 13. Not-shown receptacles, to which electric power is supplied, are arranged on the inner side of the connection holes 14. The connection holes 14 are long holes having an arcuate shape concentric to the center of the socket main body 12. Expanded diameter sections 15 are integrally formed at one ends of the long holes.

The light source unit 1 is detachably attached to such a socket 11. Specifically, a protrusion section 7A of a cap 7 of the light source unit 1 to be explained below is fit in the through-hole 12A of the socket 11. At the same time, electrode sections 8 of the light source unit 1 are inserted through the expanded diameter sections 15 of the socket sections 13. The light source unit 1 is rotated in a clockwise direction in FIG. 3, whereby the electrode sections 8 of the light source unit 1 move from the expanded diameter sections 15 to the connection holes 14 while sliding. When the electrode sections 8 reach proximal ends of the connection holes 14, the electrode sections 8 are electrically connected to the not-shown receptacles and, at the same time, fixed. In this way, the light source unit 1 is attached to the socket 11.

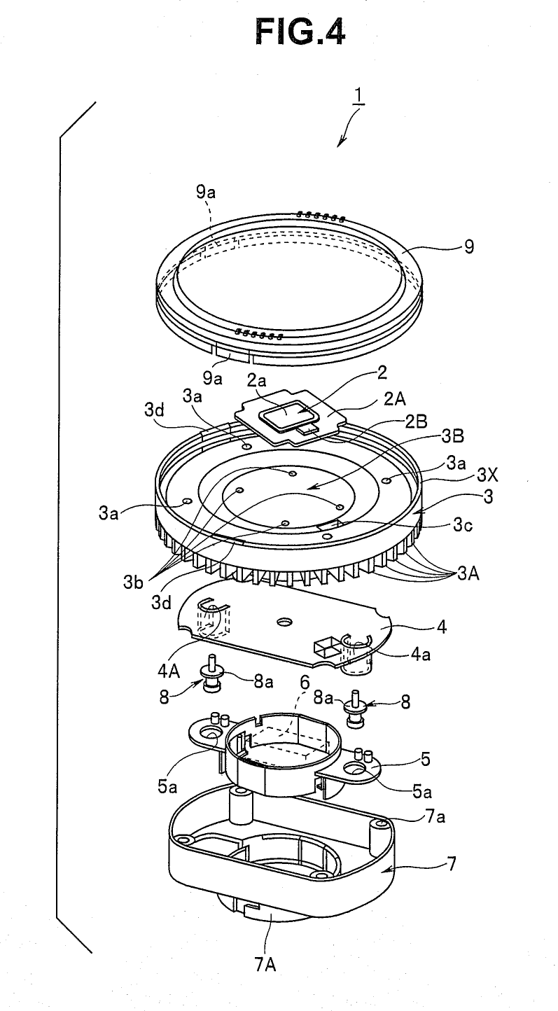

The configuration and the assembly structure of the light source unit 1 according to this embodiment are explained with reference to FIGS. 1 to 4. FIG. 4 is an exploded perspective view of the light source unit shown in FIG. 1.

As shown in FIGS. 1 to 4, the light source unit 1 according to this embodiment includes a light source module 2, a main body 3, an upper lid 4, a power supply circuit case 5, a power supply circuit 6, the cap 7, the pair of electrode sections 8, and a globe 9.

The light source module 2 is, for example, an LED module in which a light emitting surface 2a is formed by arranging plural LEDs (not shown in the figures), which function as light emitting devices, thereon. The LED module 2 includes the light emitting surface 2a of a chip on board (COB)) type formed by arranging plural LEDs thereon. Although not-shown in the figure, the light emitting surface 2a is formed by arranging plural LEDs, which are light emitting devices, in lengthwise and crosswise directions on a substrate.

The LED module 2 includes a substrate 2A to which the LEDs are electrically connected and a connector 2B set on the substrate 2A and configured to electrically connect a connection line from the power supply circuit 6 and the LEDs.

The light emitting devices included in the light source module 2 are not limited to the LEDs and may be luminous bodies such as organic ELs. Either one light emitting device or plural light emitting devices may be provided.

The light emitting surface 2a is formed by arranging the plural LEDs in the lengthwise and crosswise directions. However, the light emitting surface 2a is not limited to this. The light emitting surface 2a may be formed by, for example, arranging the plural LEDs in a circular shape on a substrate.

The main body 3 is formed to have thermal conductivity by a manufacturing method such as die cast using a member such as metal. The main body 3 includes a setting surface section 3B on which the LED module 2 is set and thermal radiating fins 3A disposed on the rear surface of the setting surface section 3B on the outer circumferential side and radiating heat received from the LED module 2 and the power supply circuit 6. A wall section for fitting the globe 9 is formed at an outer circumferential edge 3X on the setting surface section 3B side of the main body 3.

In the setting surface section 3B of the main body 3, as shown in FIG. 4, four screw holes 3b are provided. In a state in which the substrate 2A of the LED module 2 is placed on the setting surface section 3B, not-shown screws are respectively screwed in the screw holes 3b, whereby the LED module 2 is fixed on the setting surface section 3B. A not-shown connection line connected to the connector 2B of the LED module 2 is led to the power supply circuit 6 disposed on the rear side of the main body 3 via a connection hole 3c provided near the setting surface section 3B.

As shown in FIG. 2, the plural thermal radiating fins 3A are disposed in the outer circumferential section of the surface on the rear side of the setting surface section 3B of the main body 3. The thermal radiating fins 3A form a thermal radiating section for radiating heat generated in the light source unit 1. However, the thermal radiating section is not limited to this. For example, the thermal radiating section may be formed by plural needles. It goes without saying that, besides the thermal radiating fins and the needles, the thermal radiating section may be formed in any structure as long as a surface area is increased and effective thermal radiation action is obtained.

On the rear side of the setting surface section 3B of the main body 3, as shown in FIG. 4, the upper lid 4 and the cap 7 having stored therein the power supply circuit case 5, in which the power supply circuit 6 is stored, are attached.

In this case, the power supply circuit case 5, in which the power supply circuit 6 is stored, is stored in the cap 7. The electrode sections 8 are respectively fit in electrode section attachment holes 5a provided on both sides of the power supply circuit case 5. The upper lid 4 is put over the cap 7 from the upper direction in FIG. 4. At this point, pins of the electrode sections 8 are inserted through slits of substantially C-shaped collars 4a, 4a of the upper lid 4. At the same time, locking sections 8a provided in the electrode sections 8 are respectively locked to the collars 4a, 4a. The locking sections 8a of the electrode sections 8 are locked to the collars 4a, 4a, whereby the movement of the electrode sections 8 in the direction of the main body 3 is regulated.

The cap 7 having stored therein the power supply circuit case 5, the pair of electrode sections 8, and the upper lid 4 in this way is arranged on the surface on the rear side of the setting surface section 3B of the main body 3. Not-shown screws are respectively inserted through plural holes 3a provided around the setting surface section 3B of the main body 3 and, at the same time, respectively screwed in plural screw holes 7a provided in the cap 7. Consequently, the cap 7 is fixed to the surface on the rear side of the setting surface section 3B of the main body 3.

The cap 7 is formed of a synthetic resin section having electrical insulation properties and is insulated from the pair of electrode sections 8 and the power supply circuit 6.

On the other hand, plural engaging grooves 3d are provided on the inner circumferential surface of the outer circumferential edge 3X on the setting surface section 3B side of the main body 3. An engaging section 9a of the globe 9 engages with the plural engaging grooves 3d, whereby the globe 9 can be fixed to the main body 3. The globe 9 is formed of a transparent or light diffusing synthetic resin material having translucency such as polycarbonate and is formed in a bottomed flat cylindrical shape.

In this way, the light source unit 1 according to this embodiment shown in FIGS. 1, 2, and 4 can be assembled.

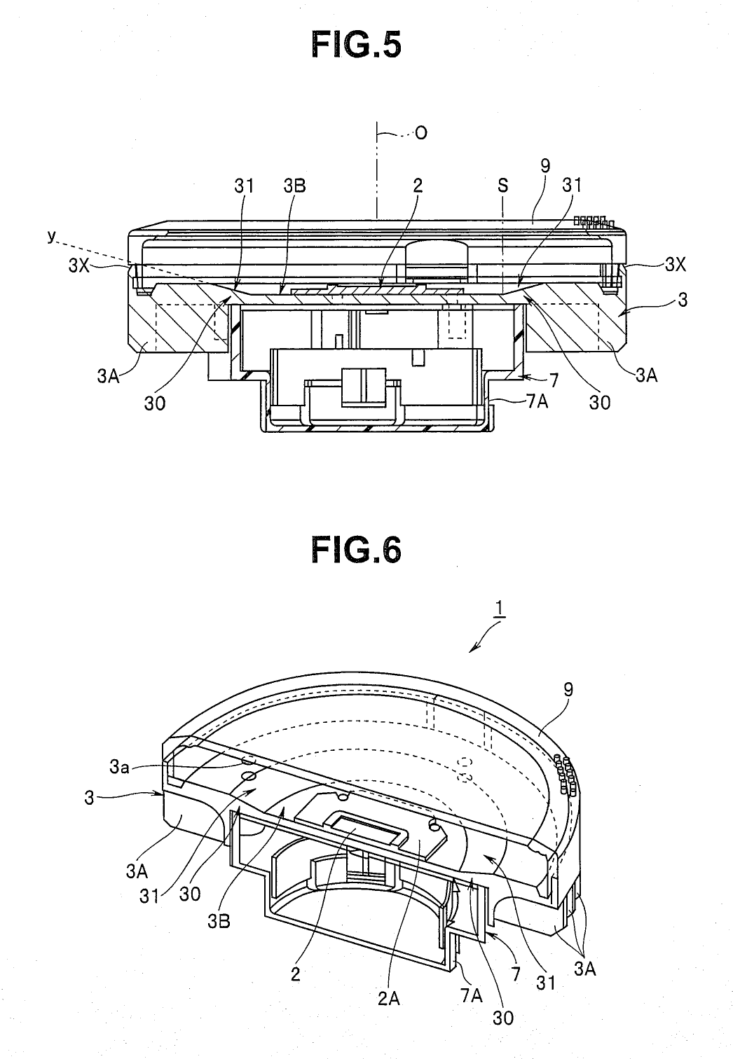

The configuration of a main part, which is a characteristic of the light source unit 1 according to this embodiment, is explained with reference to FIGS. 5 to 9.

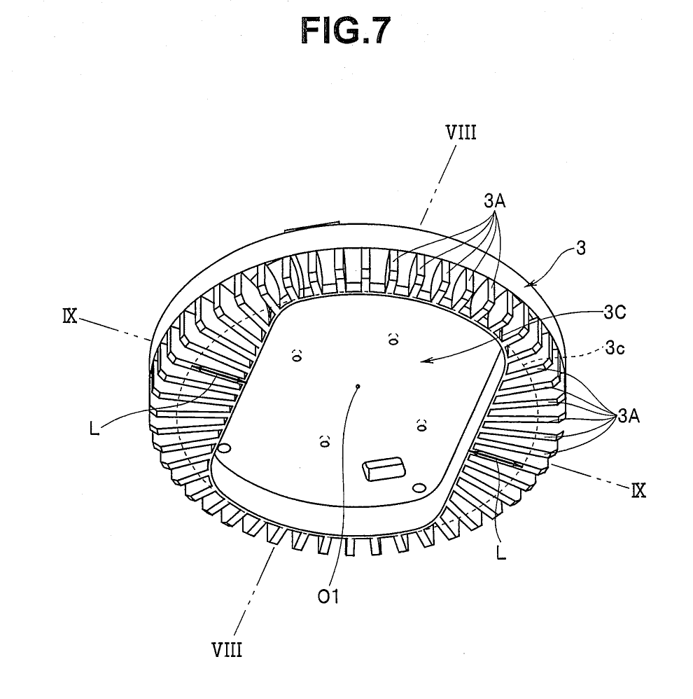

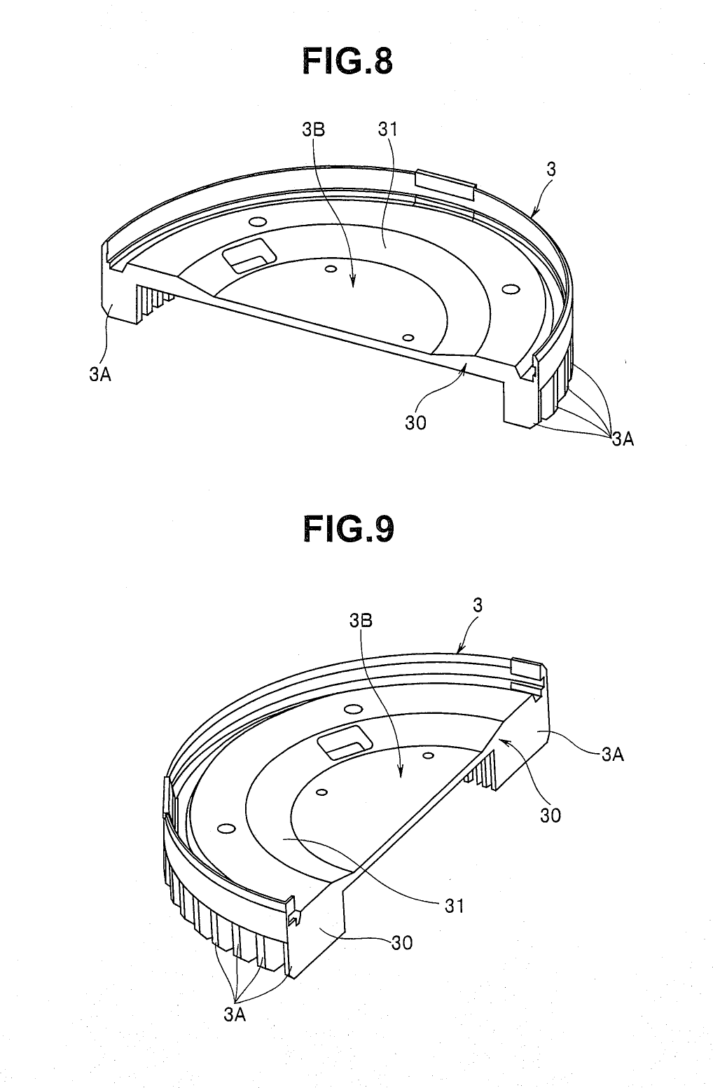

FIG. 5 is a perspective view of a V-V line cross section of FIG. 2 for explaining the configuration of a main part of the light source unit according to this embodiment. FIG. 6 is a perspective view of the light source unit taken along the cross section shown in FIG. 5. FIG. 7 is a perspective view of an external configuration of a main body shown in FIG. 4 viewed from the thermal radiating section side. FIG. 8 is a perspective view of a VIII-VIII line cross section shown in FIG. 7. FIG. 9 is a perspective view of a IX-IX line cross section shown in FIG. 7.

As shown in FIGS. 5 and 6, in the light source unit 1 according to this embodiment, the main body 3 includes a thick section 30 arranged between the setting surface section 3B and the thermal radiating fins 3A.

The thick section 30 includes, in a cross section of the main body 3 in a direction along an optical axis O direction of the LED module 2, an inclined plane 31 that inclines from the LED module 2 toward the outer side to divert light to an irradiation direction of light of the LED module 2. The inclined plane 31 is formed to be thicker than the setting surface section 3B.

An inclination angle of the inclined plane 31 is not specifically limited and only has to be an inclination angle at which light can be reflected to be diverted to the irradiation direction of the light of the LED module 2. The thickness of the inclined plane 31 is formed to be larger than the thickness of the setting surface section 3B. However, it is desirable to form the inclined plane 31 to have thickness at which thermal conductivity can be increased.

For example, white paint is applied to the surfaces of the setting surface section 3B and the inclined plane 31 of the main body 3 except a portion where the substrate 2A of the LED module 2 is arranged. The light from the LED module 2 is effectively reflected in the irradiation direction of the light.

As shown in FIG. 5, in the light source unit 1 according to this embodiment, the proximal end of the cap 7 is set in contact with the surface on the opposite side of the inclined plane 31 of the thick section 30 of the main body 3. The proximal end of the cap 7 is provided in contact with the surface on the opposite side of the inclined plane 31 of the thick section 30 of the main body 3. Therefore, even if heat generated by the power supply circuit 6 is transferred to the cap 7, the heat transferred to the cap 7 is actively transferred to the thick section 30 of the main body 3.

In the light source unit 1 according to this embodiment, the thick section 30 including the inclined plane 31 is thicker than the setting surface section 3B. Therefore, the thick section 30 has smaller thermal resistance. Further, since the inclined plane 31 is formed, the thickness of the thick section 30 gradually increases toward the outer side. Therefore, since the thermal resistance of the thick section 30 further decreases, thermal conductivity increases. Therefore, it is possible to transfer a larger heat quantity to the thermal radiating fins 3A side. At the same time, it is possible to radiate heat transferred by the main body 3 itself and the thermal radiating fins 3A.

In the light source unit 1 according to this embodiment, as shown in FIG. 7, on the rear side of the main body 3 viewed from a slightly oblique direction of the optical axis O of the LED module 2, part of the thermal radiating fins 3A are formed closer to at least a part of the thick section 30. The surface area of the thermal radiating fins 3A connected to at least the part of the thick section 30 is formed large.

In other words, when viewed from the optical axis O direction of the light source module 2, a part of the thermal radiating section of the main body 3 is formed closer to the at least the part of the thick section 30.

The shape of a recess formed on the inner side of the plural thermal radiating fins 3A is usually formed in a substantially arcuate shape as indicated by a dotted line in FIG. 7. However, in this embodiment, as shown in FIG. 7, a predetermined number of thermal radiating fins 3A arranged to be opposed to each other based on the shape of the thick section 30 are formed closer to the part of the thick section 30 by a distance L from the dotted line. Therefore, the shape of the recess formed on the inner side of the plural thermal radiating fins 3A is a track field shape.

Therefore, compared with the thermal radiating fins 3A not close to a center axis O1 of the main body 3 (see FIG. 8), the thermal radiating fins 3A close to the center axis O1 expand in a direction orthogonal to the optical axis O direction of the LED module 2. Therefore, since the surface areas of the thermal radiating fins 3A increases, it is possible to further improve the thermal radiation action.

The shape of the recess formed on the inner side of the plural thermal radiating fins 3A is not limited to the track field shape shown in FIG. 7. For example, the recess may be formed in a polygonal shape such as a rectangular shape or an arcuate shape.

The action of the light source unit 1 according to this embodiment is explained with reference to FIGS. 5 to 9.

In the light source unit 1 according to this embodiment, the main body 3 includes the thick section 30 thicker than the setting surface section 3B and having small thermal resistance and high thermal conductivity. Further, since the inclined plane 31 is formed, the thickness of the thick section 30 gradually increases toward the outer side.

Therefore, since the thermal resistance of the thick section 30 further decreases and the thermal conductivity of the thick section 30 further increases, it is possible to transfer a larger amount of heat to the thermal radiating fins 3A side.

Therefore, even if the heat from the LED module 2 and the heat from the cap 7 join in the thick section 30 of the main body 3, since the thermal resistance of the thick section 30 of the main body 3 is small, it is possible to absorb a large amount of heat and radiate the heat in the main body 3 itself. At the same time, it is possible to transfer a larger amount of heat to the thermal radiating fins 3A side and radiate the heat to the outside of the main body 3 using the thermal radiating fins 3A.

At this point, it is possible to further improve the thermal radiation effect using the plural thermal radiating fins 3A formed closer to the center axis O1 of the main body 3 and having the large surface area as shown in FIG. 7.

Further, in the light source unit 1 according to this embodiment, the inclined plane 31 of the thick section 30 of the main body 3 inclines from the LED module 2 toward the outer side to divert the light of the LED module 2 to the irradiation direction.

Therefore, in the cross section of the main body 3 along the optical axis O direction of the LED module 2, even if the wall section formed at the outer circumferential edge 3X on the setting surface section 3B side of the main body 3 of the LED module 2 is arranged in a position higher than the LED module 2 arranged in the setting surface section 3B, it is possible to reflect, using the inclined plane 31, a part of a light beam emitted from the LED module 2 to be diverted to the irradiation direction of the light of the LED module 2. Consequently, it is possible to reduce a light beam loss of the light source device.

In the light source unit 1 according to this embodiment, as shown in FIG. 5, in the cross section of the main body 3 in the direction along the optical axis O direction of the LED module 2, the outer circumferential edge 3X of the main body 3 is arranged on an extended line y of the inclined plane 31 or on a lower side than the extended line y. In other words, in the first place, the light source unit 1 has structure in which a part of a light beam emitted from the LED unit 2 is not irradiated on the wall section formed at the outer circumferential edge 3X of the main body 3. Therefore, it is possible to more surely reduce a light beam loss.

In the light source unit 1 according to this embodiment, as shown in FIG. 4, on the plane of the main body 3 viewed from the optical axis O direction of the LED module 2, the shape of the setting surface section 3B formed on the inner side from an S portion (see FIG. 5) where the inclination of the inclined plane 31 starts may be used for positioning in setting the LED module 2. Consequently, it is possible to simplify assembly work in attaching the LED module 2 to the setting surface section 3B of the main body 3.

Further, as shown in FIG. 5, in the cross section of the main body 3 in the direction along the optical axis O direction of the LED module 2, the LED module 2 may be arranged in a position lower than the thick section 30 of the main body 3. Consequently, it is possible to more effectively lead a light beam emitted from the LED module 2 to the inclined plane 31 and more surely reduce a light beam loss.

Therefore, according to this embodiment, it is possible to realize the light source unit 1 that can effectively radiate heat generated in the light source unit 1 to the outside of the main body 3 and reduce a loss of a light beam from the LED module 2, the light source device including the light source unit 1, and the luminaire 10 including the light source device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light source unit comprising:
a light source module including at least one light emitting device; and
a main body including:
a setting surface section on which the light source module is set;
a thermal radiating section disposed around the setting surface section and configured to radiate heat received from the light source module; and
a thick section arranged between the setting surface section and the thermal radiating section and including an inclined plane that has thickness larger than thickness of the setting surface section and inclines in an irradiation direction from the light source module toward an outer side.

2. The unit according to claim 1, wherein, when viewed from an optical axis direction of the light source module, a part of the thermal radiating section of the main body is formed closer to at least a part of the thick section.

3. The unit according to claim 1, wherein, in a cross section of the main body in a direction along an optical axis direction of the light source module, an outer circumferential edge of the main body is arranged on an extended line of the inclined plane or on a lower side than the extended line.

4. The unit according to claim 1, wherein, on a plane on the setting surface side of the main body viewed from an optical axis direction of the light source module, a shape of the setting surface section formed on an inner side from a portion where inclination of the inclined plane starts is used for positioning in setting the light source module.

5. The unit according to claim 1, wherein, in a cross section of the main body in a direction along an optical axis direction of the light source module, the light source module is arranged in a position lower than the thick section of the main body.

6. The unit according to claim 1, wherein paint that reflects light from the light source module is applied to the inclined plane.

7. The unit according to claim 1, wherein an inclination angle of the inclined plane is an angle at which light can be reflected to be diverted to an irradiation direction of light of the light source module.

8. A light source device comprising:
a light source unit including:
a light source module including at least one light emitting device; and
a main body including:
a setting surface section on which the light source module is set;
a thermal radiating section disposed around the setting surface section and configured to radiate heat received from the light source module; and
a thick section arranged between the setting surface section and the thermal radiating section and including an inclined plane that has thickness larger than thickness of the setting surface section and inclines in an irradiation direction from the light source module toward an outer side;
a power supply circuit for lighting the light source module of the light source unit; and
a cap configured to store the power supply circuit and attached to the main body.

9. The device according to claim 8, wherein a proximal end of the cap is provided in contact with a surface on an opposite side of the inclined plane of the thick section of the main body.

10. The device according to claim 8, wherein, when viewed from an optical axis direction of the light source module, a part of the thermal radiating section of the main body is formed closer to at least a part of the thick section.

11. The device according to claim 8, wherein, in a cross section of the main body in a direction along an optical axis direction of the light source module, an outer circumferential edge of the main body is arranged on an extended line of the inclined plane or on a lower side than the extended line.

12. The device according to claim 8, wherein, on a plane on the setting surface section side of the main body viewed from an optical axis direction of the light source module, a shape of the setting surface section formed on an inner side from a portion where inclination of the inclined plane starts is used for positioning in setting the light source module.

13. The device according to claim 8, wherein, in a cross section of the main body in a direction along an optical axis direction of the light source module, the light source module is arranged in a position lower than the thick section of the main body.

14. The device according to claim 8, wherein paint that reflects light from the light source module is applied to the inclined plane.

15. The device according to claim 8, wherein an inclination angle of the inclined plane is an angle at which light can be reflected to be diverted to an irradiation direction of light of the light source module.

16. A luminaire comprising:
a light source device; and
a socket to which a cap of the light source device is detachably attached, wherein
the light source device includes:
a light source unit including:
a light source module including at least one light emitting device; and
a main body including:
a setting surface section on which the light source module is set;
a thermal radiating section disposed around the setting surface section and configured to radiate heat received from the light source module; and
a thick section arranged between the setting surface section and the thermal radiating section and including an inclined plane that has thickness larger than thickness of the setting surface section and inclines in an irradiation direction from the light source module toward an outer side;
a power supply circuit for lighting the light source module of the light source unit; and
a cap configured to store the power supply circuit and attached to the main body.

17. The luminaire according to claim 16, wherein a proximal end of the cap is provided in contact with a surface on an opposite side of the inclined plane of the thick section of the main body.

18. The luminaire according to claim 16, wherein, when viewed from an optical axis direction of the light source module, a part of the thermal radiating section of the main body is formed closer to at least a part of the thick section.

19. The luminaire according to claim 16, wherein, in a cross section of the main body in a direction along an optical axis direction of the light source module, an outer circumferential edge of the main body is arranged on an extended line of the inclined plane or on a lower side than the extended line.

20. The luminaire according to claim 16, wherein, on a plane on the setting surface side of the main body viewed from an optical axis direction of the light source module, a shape of the setting surface section formed on an inner side from a portion where inclination of the inclined plane starts is used for positioning in setting the light source module.
